(19) United States
(12) Patent Application Publication
(10) Pub. No.: US 2025/0165493 A1
(43) Pub. Date: May 22, 2025

(54) AUTOMATED CONVERSION OF DATA TRANSFORMATION FUNCTIONS

(71) Applicant: AMERICAN EXPRESS TRAVEL RELATED SERVICES COMPANY, INC., New York, NY (US)

(72) Inventors: Pulkit AGGARWAL, Chandigarh (IN); Ritesh Kumar BANSAL, Haryana (IN); Aman MADAN, Toronto (CA); Phanikalyan CHERUKURI, Phoenix, AZ (US); Ashok NAIR, Phoenix, AZ (US); Man Chon U, Sunrise, FL (US); Bimal RAMANKUTTY, Phoenix, AZ (US); Jogendra Singh ROHILA, Phoenix, AZ (US); Kavita GUPTA, Princeton, NJ (US); Purvi SHAH, New York, NY (US)

(73) Assignee: AMERICAN EXPRESS TRAVEL RELATED SERVICES COMPANY, INC., New York, NY (US)

(21) Appl. No.: 18/514,293

(22) Filed: Nov. 20, 2023

(51) Int. Cl. G06F 16/25

(52) U.S. Cl. CPC G06F 16/258

(57) ABSTRACT

Disclosed herein are system, method, and computer program product embodiments for converting data transformation functions for one data consolidation tool to another data consolidation tool. A transformation function conversion system converts one or more first data transformation functions to one or more second data transformation functions using a mapping configuration file. The mapping configuration file includes direct and/or indirect mappings for data transformation functions. This may translate one or more functions from the first data consolidation tool to the second data consolidation tool. The transformation function conversion system may also convert configuration files containing the data transformation functions and/or metadata. The transformation function conversion system also generates a graphical user interface (GUI) with a visual representation of the data transformation process. Data transformation functions may be converted from a locally hosted data warehouse system to a cloud-based data warehouse system.

### BACKGROUND

### Field

This field is generally related to converting a first data transformation function for a first data consolidation tool to a second data transformation function that can be executed using a second data consolidation tool.

### Related Art

As enterprise computing systems and technologies continue to evolve, businesses face the issue of managing massive sets of data. These datasets may be transformed using data consolidation tools, such as extract-transform-load (ETL) tools. These tools allow data from various sources to be transformed into a single format, which can then be loaded into a target database. The transformed data may be initially uploaded and then continuously updated as data continues to be gathered. Data consolidation tools, such as ETL tools, create improved data management and governance. Additionally, data may be stored in required formats for use in various data analytics and enterprise systems across an organization.

These tools however may also become obsolete or organizations may decide to move operations from one tool to another for various reasons such as cost or functionality. A drawback of migrating data transformation processes from one data consolidation tool to another data consolidation tool is that each of the data transformation processes must be recreated in the second data consolidation tool. The time required to recreate the existing data transformation processes in the second data consolidation tool may be inefficient and costly, creating a large obstacle to migrating the existing data transformation processes to the second data consolidation tool. Additionally, because the first data consolidation tool generally updates the data in an existing database, the format of the output of the second data consolidation tool should be identical the format of the output of the first data consolidation tool. Such outputs may be difficult to reproduce. Additionally, manual recreation of data transformation processes may introduce a greater opportunity for error, which may also lead to computing inefficiencies or erroneous data processing.

### BRIEF SUMMARY

Disclosed herein are system, apparatus, device, method and/or computer program product embodiments, and/or combinations and sub-combinations thereof, for converting a first data transformation function for a first data consolidation tool (e.g. extract-transform-load (ETL) tool) to a second data transformation function that can be executed with a second data consolidation tool. In some embodiments, the systems and methods described herein may be used to convert files from a legacy ETL tool to a cloud based ETL tool.

In some embodiments, a configuration file conversion system receives a set of data configuration files to convert from a first data consolidation tool format to a second data consolidation tool format. As will be further described below, the configuration file conversion system may use a mapping of functions to perform the conversion. The mapping may include direct function mappings and/or indirect function mappings. Direct function mappings may refer to functions that exist in both the first and second data consolidation tools. Indirect function mappings may refer to functions that exist in the first data consolidation tool format but may not have a direct conversion in the second data consolidation tool format. For example, there may be a combination of non-equivalent functions, based on the operations of the function of the first data consolidation tool, for the second data consolidation tool. To account for these differences, the configuration file conversion system performs the indirect function mapping to create a set of data configuration files that can be executed by the second data configuration tool to produce that same output as the first data consolidation tool.

The configuration file conversion system may additionally generate, for the data configuration files to be executed by the second data consolidation tool, a graphical user interface (GUI). When executed in the second data consolidation tool, the GUI may display a visual representation of the data transformation process defined by a data configuration file. Displaying the data transformation process may allow the user to quickly confirm that the datasets from one or more data sources will be transformed into the correct output. Additionally, the visual representation of the data transformation process may be used to interact with the data transformation process. For example, the data transformation process, data sources, and/or the target output location may be modified.

As further described below, the configuration file conversion system converts a data configuration file from the first data consolidation tool to a data configuration file that can be executed in the second data consolidation tool. To provide an example of the context for the data configuration file conversion, this disclosure will describe the conversion of a first extract-transform-load (ETL) tool to a second ETL tool. For example, to migrate from a locally hosted ETL tool to a cloud platform ETL tool. However, conversions may be made from a first locally hosted ETL tool to a second locally hosted ETL, cloud based ETL tools, or any combination thereof. The locally hosted-to-cloud based conversion is provided as an example and does not limit the disclosure solely to this type of conversion. Rather, the conversion of data configuration files described herein may apply to other ETL and/or data consolidation tools as further described below.

By automatically converting data configuration files, configuration file conversion system provides computing efficiencies. For example, the configuration file conversion system may provide savings on computing processing by automating potentially manual re-creation of data transformation processes in another data consolidation tool. To provide these efficiencies, the configuration file conversion system may utilize a mapping configuration file with a mapping of direct functions and indirect functions to convert data transformation. This configuration file may account for the mapping of functions, and the operations of functions, to construct data configuration files in the proper second data consolidation tool format. Additionally, time efficiencies may also be provided as the configuration file conversion system is able to quickly generate a converted data configuration file. The configuration file conversion system may provide time savings relative to manual recreation of new data transformation processes. Configuration file conversion system may also reduce the number of errors by using an existing mapping configuration file for migrating to a specific data consolidation tool. The mapping configuration file generated for the second data consolidation tool may be tested before use to determine the direct and indirect function equivalents in the second data consolidation tool for each function in the first data consolidation tool. Additionally, as further described below, if an error occurs or no mapping exists for a given data transformation function, the configuration file conversion system may also generate an alert identifying any potential errors in conversion. This may alert a system administrator or data analyst of any substitutions that may be made. Additionally, the alert may indicate on the GUI which data transformation function potentially has an error. This alert may be useful when automating the conversion of a massive number of data configuration files. In this manner, the configuration file conversion system may automate the conversion of a large volume of enterprise-wide data configuration files and/or automate the conversion of potentially hundreds of thousands of data transformation processes.

### BRIEF DESCRIPTION OF THE DRAWINGS

The accompanying drawings are incorporated herein and form a part of the specification.

FIG. 1A depicts a block diagram of a data transformation function conversion environment, according to some embodiments.

FIG. 1B depicts a block diagram of a transformation function conversion system, according to some embodiments.

FIG. 2 depicts an example graphical user interface displaying converted data transformation functions, according to some embodiments.

FIG. 3A depicts a flowchart illustrating a method for converting one or more data transformation functions for a first data consolidation tool to data transformation functions for a second data configuration tool, according to some embodiments.

FIG. 3B depicts a flowchart illustrating a method for identifying a replacement data transformation function in response to identifying a lack of a direct or indirect equivalent data transformation function, according to some embodiments.

FIG. 4 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for converting a first data configuration file written for a first data consolidation tool to a second data configuration file that can be executed using a second data consolidation tool.

Various embodiments of these features will now be discussed with respect to the corresponding figures.

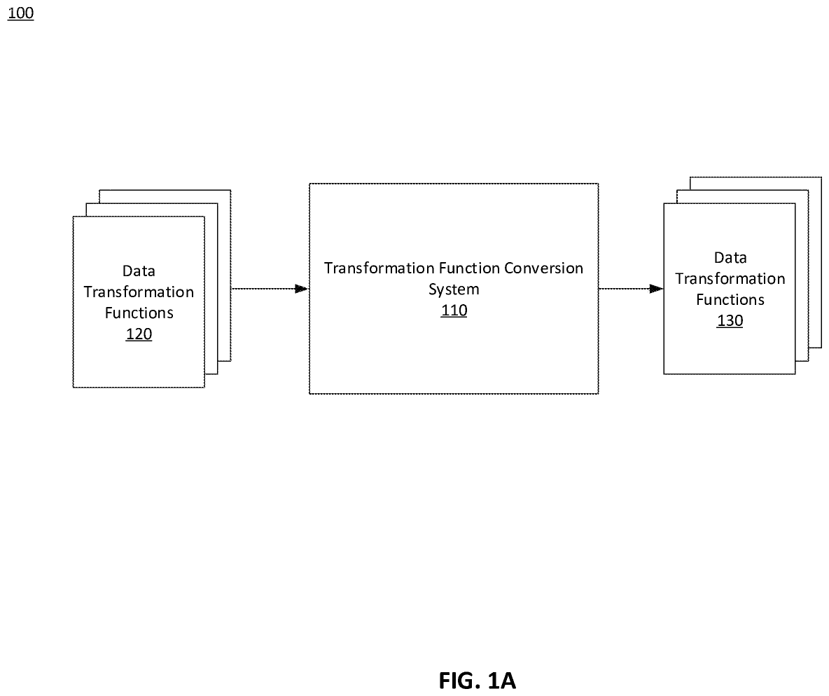

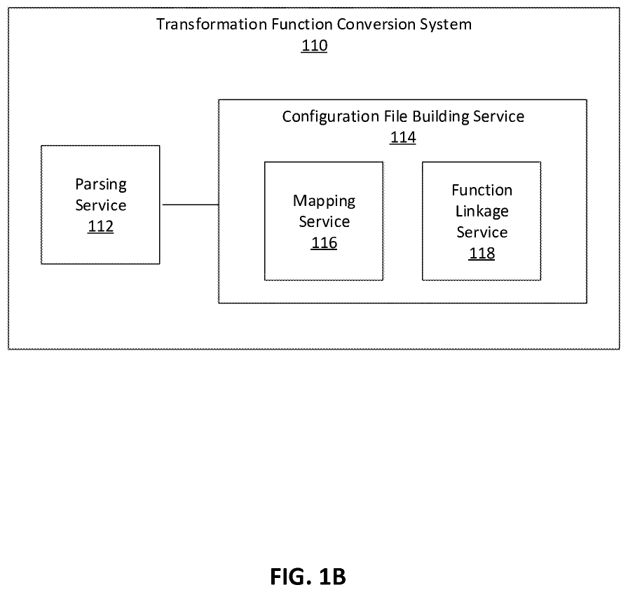

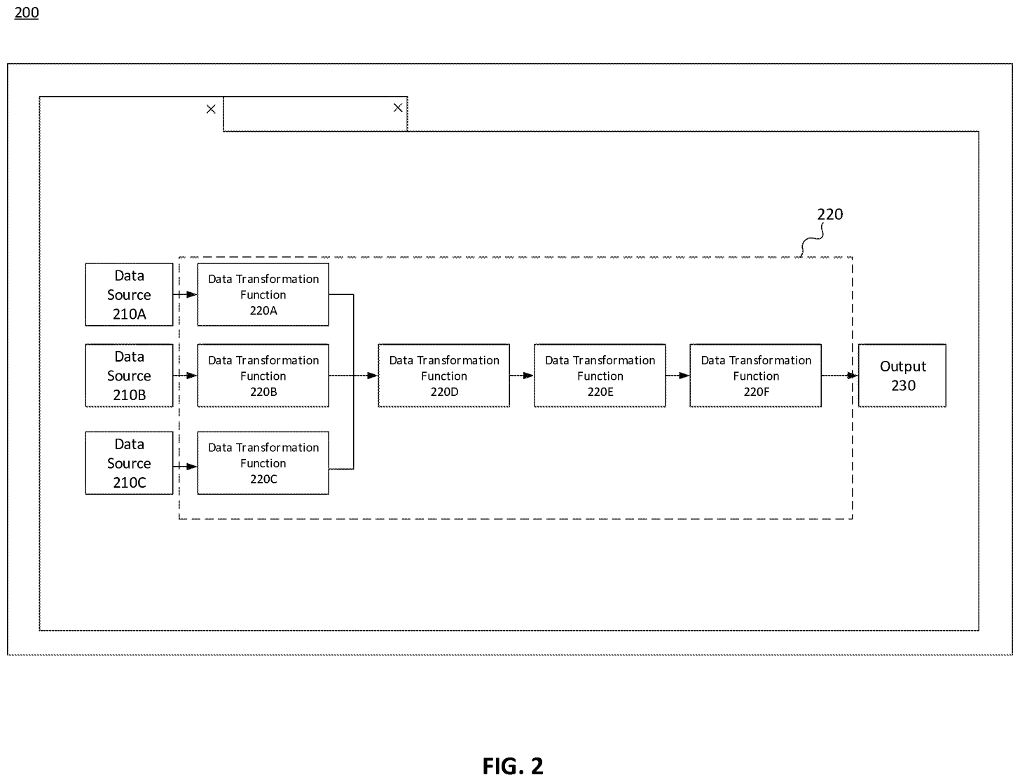

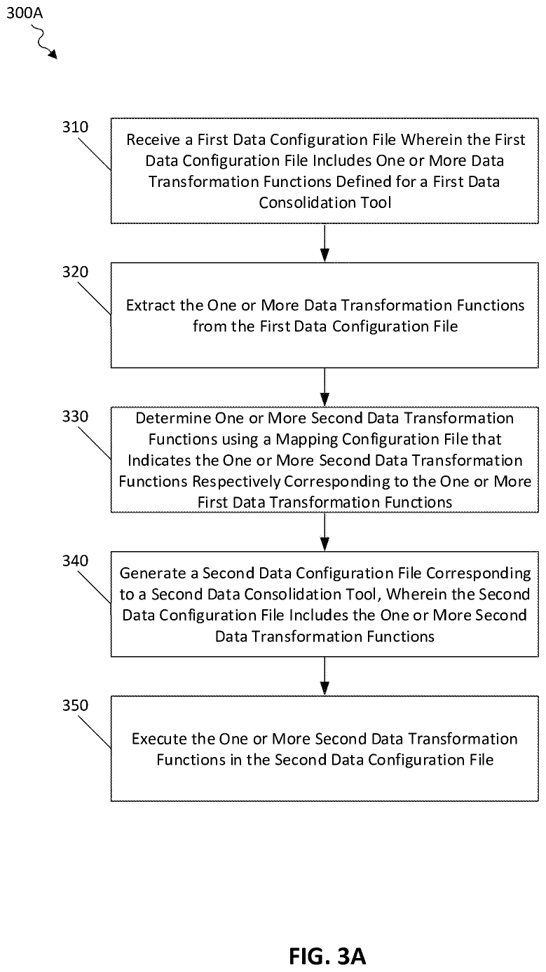

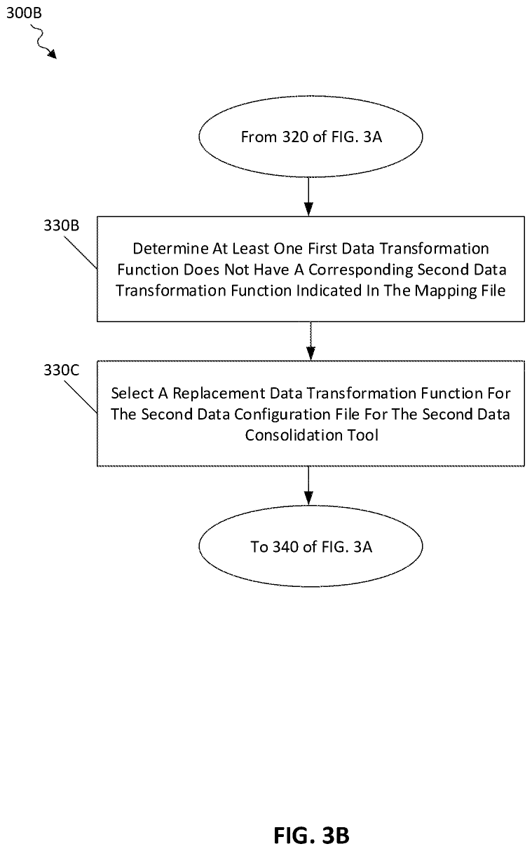

FIG. 1A depicts a block diagram of a data transformation function conversion environment 100, according to some embodiments. Data transformation function conversion environment 100 includes data transformation functions 120, transformation function conversion system 110, and data transformation functions 130. In some embodiments, data transformation functions 120 and/or 130 may be organized into files. For example, data transformation functions 120 and/or 130 may be organized into configuration files. Such configuration files may be used to manipulate and/or interact with one or more datasets. The configuration files may be applied to perform different data transformation processes. In some embodiments, data transformation functions 120 may be organized into a file used by a first extract-transform-load (ETL) tool. Data transformation functions 130 may be organized into a file used by a second ETL tool. Transformation function conversion system 110 may convert data transformation functions 120 to data transformation functions 130. As further described below, transformation function conversion system 110 may execute methods and/or programming described with references to FIG. 1B, FIG. 2, and/or FIGS. 3A-3B.

In some embodiments, transformation function conversion system 110 may convert files containing data transformation functions 120 for a data transformation process for a first data consolidation tool. In some embodiments, the data transformation functions 120 may be in a data container or other data identifier (DID). Transformation function conversion system 110 may convert one or more data transformation functions 120 exported from a first data consolidation tool to one or more data transformation functions 130 capable of being executed by a second data consolidation tool. Transformation function conversion system 110 may also convert one or more data configuration files including data transformation functions 120 to one or more data configuration files including data transformation functions 130. Additionally, when referring to converting files, this could also include other data identifiers (DID) such as containers.

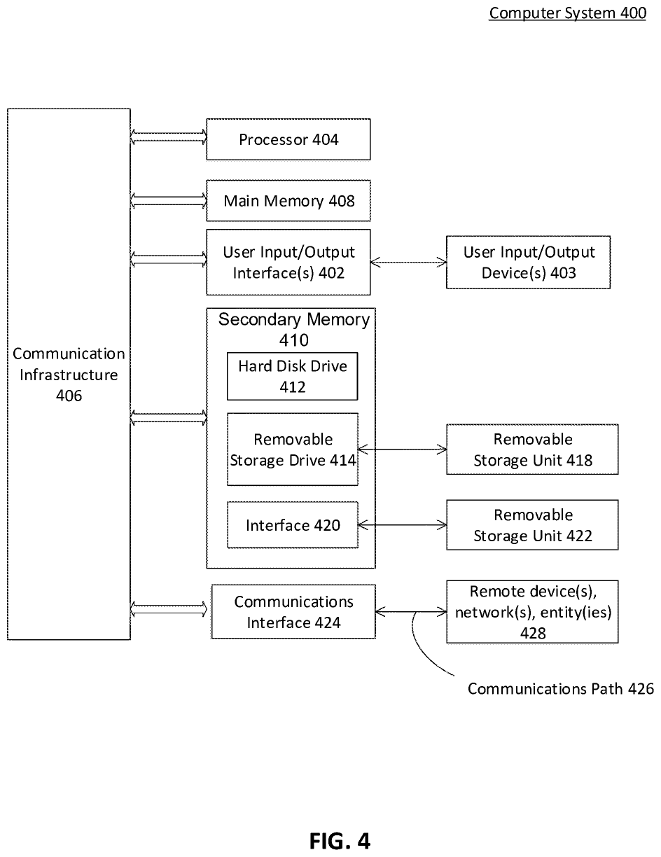

Transformation function conversion system 110 may be a computer system such as computer system 400 described with reference to FIG. 4. For example, transformation function conversion system 110 may be implemented using one or more servers and/or databases. In some embodiments, transformation function conversion system 110 may be implemented using a computing device such as a desktop workstation, laptop or notebook computer, netbook, tablet, smart phone, and/or other computing device. In some embodiments, transformation function conversion system 110 may be implemented as an application in an enterprise computing system.

To convert data transformation functions 120, transformation function conversion system 110 may retrieve and/or load data transformation functions 120. For example, data configuration files may have been stored in memory of transformation function conversion system 110. In some embodiments, transformation function conversion system 110 may receive data transformation functions 120 from one or more applications executed on an enterprise computing system. For example, this may be a cloud computing platform and/or a web application used to interface with data stored or managed by the enterprise computing system. In some embodiments, transformation function conversion system 110 may receive data transformation functions 120 as an output from a first data consolidation tool. Data transformation functions 120 include information for a data consolidation tool to perform the operations and functions to manipulate the data. For example, a data consolidation tool may be an extract-transform-load (ETL) tool. The ETL tool may receive data from various sources in multiple formats and/or manipulate the data into a standardized format.

After conversion, transformation function conversion system 110 may generate data transformation functions 130. Data transformation functions 130 may be executed by and/or when using the second data consolidation tool. These files may be configuration files similar to and/or provide data manipulation functionality similar to data transformation functions 120 when executed by the second data consolidation tool. For example, data from the same sources identified in data transformation functions 120 may be manipulated into a particular format, such that the data format output by the second ETL tool matches the data format of the output by the first ETL tool. This data can be used in data analytics systems, similar to the output of the first ETL tool.

Transformation function conversion system 110 may allow a data transformation process performed by one data consolidation tool to be converted to an equivalent data transformation process performed by a second data consolidation tool. This may occur without having to manually create transformation logic in the second data consolidation tool. As data consolidation tools, such as ETL tools, advance it may be preferential to migrate data transformation operations from one ETL tool to another. The volume of transformation instructions, however, may make this process inefficient. For example, businesses may want to move from a locally hosted ETL tool to a cloud based ETL tool. However, manually re-creating all of the existing data transformations, represented by individual data configuration files, would be inefficient. This may also leave the new data transformations open to input error. Transformation function conversion system 110 may reduce the time to migrate from one data consolidation tool to another, by automatically converting data large volumes of data configuration files for one data consolidation tool to equivalent data configuration files for the data consolidation tool. This may allow for efficient migration of data transformation operations. For example, this migration may occur without manually re-creating the data transformation operations and functions contained in data transformation functions 120.

FIG. 1B depicts a block diagram of transformation function conversion system 110, according to some embodiments. Transformation function conversion system 110 may be similar to transformation function conversion system 110 as described with reference to FIG. 1A. Transformation function conversion system 110 includes parsing service 112 and configuration file building service 114. Configuration file building service 114 includes mapping configuration file 116 and function linkage service 118. Configuration file building service 114 may generate a configuration file containing data transformation functions 130 and/or a data container formatted for the second data consolidation tool. In some embodiments, configuration file building service 114 may be used by transaction function conversion system 110 to convert data transformation functions 120 to data transformation functions 130 without also generating a configuration file.

As discussed with reference to FIG. 1A, transformation function conversion system 110 may receive data transformation functions 120 in the form of a JSON file. The JSON file may include metadata and/or data transformation functions. Parsing service 112 separates the metadata associated with the data transformation process of the configuration file and the data transformation functions 120. Regarding the data transformation functions, parsing service 112 analyzes the functions and operations contained in the file and/or data transformation functions 120 and/or identifies corresponding syntax components. For each function (or step) of the overall data transformation process defined in the file, parsing service 112 may create an abstract syntax tree for each of the syntax components. This allows configuration file building service 114 to map the data transformation functions 120 of the first data consolidation tool to one or more equivalent data transformation functions 130 of the second data consolidation tool. Configuration file building service 114 may also create a file containing data transformation function 130.

For example, in an ETL tool, a data configuration file may include one or more data transformation functions to manipulate data. For example, a configuration file may identify a first data transformation function in the data transformation process that receives or extracts data to be transformed from three different data sources (e.g. database, data warehouse, analytics tools, and/or similar data storage platforms). The datasets from the three data sources may be structured or unstructured. Each may use a different transformation to modify the data in a standardized format. Parsing service 112 may identify each of the three functions and/or operations of the functions. Parsing service 112 may create an abstract syntax tree for each of the three functions. The configuration file may also define a second transformation function to join the three individual datasets into a single dataset. Additionally, the configuration file may identify a number of other functions that may include cleanse, standardize, remove duplicates, verify, sort, filter, map, derive variables, aggregate, split, and/or other functions that may be applied to improve data quality and integrity. The configuration file may identify a loading or outputting function to load the transformed data to the target destination. Each of the functions described and/or included in the configuration file may be represented by an individual abstract syntax tree. The configuration file may include the data transformation functions 120.

Additionally, parsing service 112 separates the metadata of data transformation process for the configuration file containing data transformation functions 120. For example, this metadata may include a file name, version, business-unit designation, and/or other metadata that identifies ownership or use of the configuration file and/or data transformation functions 120 within the first data consolidation tool. This metadata may also be used to determine ownership or use in the second data consolidation tool. This allows data transformations to smoothly be migrated from one data consolidation tool to another. A configuration file containing data transformation functions 130 may preserve the same identification information from the configuration file containing data transformation functions 120. The configuration files, data transformation functions 120, and/or data transformation functions 130 may share the same metadata. This metadata may be used by their respective data consolidation tools.

Configuration file building service 114 may use the abstract syntax trees created by data parsing service 112 and extracted metadata to build data transformation functions 130 and/or a configuration file include data transformation functions 130. Configuration file building service 114 may use the metadata, input data sources, and output location identified by parsing service 112. For example, this information may be specific to the data transformation functions 120. This information may not be specific to the data consolidation tool itself.

To build the data transformation functions 130, which may be organized into a configuration file, mapping service 116 may identify one or more equivalent functions available in the second data consolidation tool. Function linkage service 118 may build the linkages between each data transformation function. A linkage may be the connection between two or more data transformation functions. For example, the output of one data transformation function may be used as the input of another data transformation function. A linkage may refer to this configuration. Mapping service 116 identifies the data transformation functions 120 used by the first data consolidation tool, which may be identified in a data configuration file. Mapping service 116 individually analyzes the abstract syntax trees from parsing service 112. Mapping service 116 may determine the operations of a particular data transformation function 120 by traversing the corresponding abstract syntax tree. The corresponding manipulation or transformation operations may be determined. Mapping service 116 may then use a mapping configuration file corresponding to the second data consolidation tool to determine the corresponding one or more data transformation functions 130 in the second data consolidation tool.

In some embodiments, the data transformation functions 120, 130 may vary from the first data consolidation tool to the second data consolidation tool. In other words, there may be an indirect equivalent data transformation function 130 in the second data consolidation tool. For example, some data transformation functions 120, 130 available in the first data consolidation tool and the second data consolidation tool may have the same functionality but different names. In another example, a data transformation function 120 of the first data consolidation tool may be equivalent to the functionality of one or more data transformation functions 130 of the second data consolidation tool, or vice versa. The mapping configuration file may be one or more files. Each file may contain the possible data transformation functions of a corresponding data consolidation tool. In some embodiments, the mapping configuration file may also be a single file, which may include the data transformation functions for each data consolidation tool. Mapping service 116 may use the one or more mapping configuration files to translate the data transformation functions 120, as defined by their operations in the abstract syntax tree, to one or more equivalent data transformation functions 130 for execution in the second data consolidation tool.

In addition to identifying the data transformation functions, configuration file building service 114 may determine the linkages (e.g. sequence and inputs/outputs) between the data transformation functions via function linkage service 118. This may occur when a configuration file links a sequence of data transformation functions 130. When executed, the configuration file, using data transformation functions 130, may create an equivalent data transformation process with the same output in the second data consolidation tool. To accomplish this, equivalent second data transformation functions 130 may be executed in a particular order with particular inputs and outputs passed from data transformation function to data transformation function. The linkage is determined using the mapping configuration file, abstract syntax trees, and/or sequence of the first data transformation functions. Function linkage service 118 determines the syntax of the first data consolidation tool to build the linkages of the data transformation functions 130, which may be contained in the configuration file. Function linkage service 118 may preserve the sequence of the data transformation functions 130 as well as ensure the output of one function is properly used as the input of another. In some embodiments, function linkage service 118 may determine the source (e.g. input) and the sink (e.g. output) for each data transformation function 130. The mapping configuration file may also be used to determine the source and sink of each of the data transformation functions.

For example, with reference to FIG. 2, an example function may be a “joining” function. The configuration file may indicate multiple data sources for the “joining” function. The configuration file may also indicate a single sink. Mapping service 116 may use the mapping configuration file to determine the corresponding “joining” data transformation function 130 in the second data consolidation tool. Function linkage service 118 may also use the mapping configuration file, abstract syntax tree, and/or sequence of first data transformation functions 120 to configure the second data transformation functions 130 in data configuration file(s) into the correct sequence with the correct sources and sinks to properly perform the “joining” function. For example, a linkage may be the resulting code instructing that the input(s) of data transformation 220D (e.g. a “joining” function) correspond to the data output(s) of data transformation functions 220A-220C (e.g. formatting functions). Further, the output of data transformation function 220D may be used as the input of data transformation function 220E. Therefore, linkages may indicate sequences of the data transformation functions and/or the corresponding inputs/outputs. In some embodiments, function linkage service 118 may be used to ensure that the transformed data output of the first data consolidation tool is the same transformed data output of the second data consolidation tool when data transformation functions 130 are executed by the second data consolidation tool.

FIG. 2 depicts an example graphical user interface (GUI) 200 displaying converted data transformation functions 220, according to some embodiments. GUI 200 may include visual representations of data sources 210, second data transformation functions 220, and output 230. GUI 200 may be displayed via a browser window. In some embodiments, when the metadata corresponding to data transformation functions 120 is extracted and/or identified, metadata corresponding to visualisation aesthetics may also be extracted. For example, this metadata may be extracted from a configuration file. Transformation function conversion system 110 may convert this metadata to a format compatible with the second data consolidation tool. Using this metadata, the second data consolidation tool may generate a graphical user interface that depicts data transformation functions 130. In some embodiments, data transformation functions 130 may be included and/or organized into a configuration file. GUI 200 may display and/or visualize the content of the configuration file, which may include data transformation functions 130 and/or other metadata defined in the data configuration file. GUI 200 may be an example of such a GUI and visualization. GUI 200 may be generated by the second data consolidation tool and/or transformation function conversion system 110.

GUI 200 may be compatible with the user interface (UI) of the second data consolidation tool, but use similar visual aesthetics at the GUI in the first data consolidation tool. The information to translate from one GUI to another may also be stored in the mapping configuration file. In some embodiments, there may be a separate mapping configuration file to convert GUI 200 from the first data consolidation tool to the second data consolidation tool. For example, transformation function conversion system 110 may generate data for data transformation functions 130 and/or a configuration file containing data transformation functions 130, based on the mapping configuration file, including instructions, that when executed in the second data consolidation tool, may create a visual representation of second data transformation functions 220, corresponding data sources 210, and/or output 230. The identification of the data transformation functions 220, corresponding data sources 210, and/or output 230 may be specified in the configuration file.

GUI 200 may include icons, tiles, buttons and/or other GUI objects to visually represent each of the data sources 210, second data transformation functions 220, and/or output 230. The icons representing second data transformation functions 220 may indicate the type of data transformation function. The number of data transformation functions may vary, depending on the information in data configuration file.

For example, and with reference to the example described in FIG. 1B, GUI 200 may display the different data sources 210, such as data sources 210A-210C. There may be any number of data sources used in the data transformation process. Each data source may provide a different dataset of structured or unstructured data. The datasets may each rely on different data transformation functions to standardize the data format for later data transformation functions. For example, these may include second data transformation functions 220A-220C. For example, a first dataset may be extracted in a standardized format (e.g. structured data stored in a tabular format). A second dataset may be extracted in a semi-structured format (e.g. XML files). A third dataset may be extracted in an unstructured format (e.g. a text file). In some embodiments, one or more datasets may have the same original format when extracted and/or may share a data transformation function.

As depicted in FIG. 2, the one or more datasets may be joined in a single dataset, for example data transformation function 220D may be a “joining” function. The “joining” function may combine the standardized datasets into a single dataset. As previously explained, the standardized datasets may have been transformed using second data transformation functions 220A-220C. Once the data is combined, additional formatting functions, such as remove duplicates, verify, sort, filter, map, derive variables, aggregate, split, insert and/or other functions that may be applied to improve data quality and integrity, may be performed. These additional formatting functions are represented by second data transformation functions 220E and 220F.

In some embodiments, GUI 200 may allow a user to modify the functions and/or sequence of functions provided in a data configuration file. A user may modify GUI 200 to update the data transformation process in the data configuration file. For example, data transformation function 220E may represent a sorting data transformation function. A user, however, may wish to change this function. In response to user interaction with GUI 200, data transformation function 220E may be removed and/or replaced with a different data transformation function, such as deduplication. The second data consolidation tool and/or transformation function conversion system 110 may make this modification.

GUI 200 may also include an icon of the output 230 of the second data consolidation tool. The output may indicate information on the dataset and/or the target location where transformed data will be loaded. For example, output 230 may represent the target location for transformed data generated by the transformation process. As described above, output 230 may be used in various applications or data analytics tools.

FIG. 3A depicts a flowchart illustrating a method 300A for converting one or more data transformation functions for a first data consolidation tool to data transformation functions for a second data configuration tool, according to some embodiments. Method 300A shall be described with reference to FIGS. 1A, 1B, and 2; however, method 300A is not limited to that example embodiment. In some embodiments, data transformation functions 120 and/or 130 may be contained in one or more configuration files formatted for the first and second data consolidation tool, respectively. Additionally, the data identifier (DID) may be a format other than a configuration file, such as a data container.

In an embodiment, transformation function conversion system 110 may utilize method 300A to convert data transformation functions 120 for a first data consolidation tool to data transformation functions 130 for a second data consolidation tool. This may also occur as part of a configuration file conversion. For example, a configuration file including data transformation functions 120 may include metadata and/or functions used to transform an input dataset into an output dataset in a standardized data format. The output dataset may be stored at a target location. The data consolidation operations may be migrated from one data consolidation tool to another. For example, data transformation functions 120 may correspond to the first data consolidation tool, such as an ETL tool that is locally hosted. Data transformation functions 120 may be converted to data transformation functions 130. Data transformation functions 130 may correspond to the second data consolidation tool, such as an ETL tool that is cloud based. The foregoing description will describe an embodiment of the method 300A with respect to transformation function conversion system 110. Method 300A is described with reference to transformation function conversion system 110 and may be executed on any computing device, such as, for example, the computer system described with reference to FIG. 4 and/or processing logic that may comprise hardware (e.g., circuitry dedicated logic, programmable logic, microcode, etc.), software (e.g., instructions executing on a processing device), or combination thereof. Additionally, method 300A describes the conversion of a single data configuration file, but method 300A may be automatically performed iteratively for multiple data configuration files containing data transformation functions 120 received by transformation function conversion system 110. This allows transformation function conversion system 110 to efficiently convert data configuration files from one data consolidation tool to another, speeding up the migration process for an organization and/or user.

It is to be appreciated that not all steps may be needed to perform the disclosure provided herein. Further, some of the steps may be performed simultaneously, or in a different order than shown in FIG. 3A, as will be understood by a person of ordinary skill in the art.

At 310, transformation function conversion system 110 receives a first data configuration file. The first data configuration file includes one or more data transformation functions 120 defined for a first data consolidation tool. Transformation function conversion system 110 may receive one or more data configuration files. In some embodiments, the data configuration files 120 and/or data transformation functions 120 may correspond to the first data consolidation tool, such as an ETL tool. Each data configuration file may correspond to a specific set of input data and/or set of data transformation functions. These data transformation functions may transform input dataset(s) to a standardized format of data in the target location. In some embodiments, transformation function conversion system 110 receives the first data transformation functions 120 directly or in another format such as a data container.

The data configuration files may contain the relevant information and parameters used by the first data consolidation tool to transform a set of input data to a standardized format. The transformed data may be stored and/or used by data analytics and/or enterprise systems across an organization. In some embodiments, the relevant information may be metadata associated with the data transformation functions 120. For example, the metadata may include a file name, version, business-unit, and/or other additional metadata information used to identify the data configuration file and/or data transformation function 120. In some embodiments, the parameters may include the data source(s), input dataset(s), one or more data transformation functions, the output dataset, and/or target location of the output dataset.

At 320, transformation function conversion system 110 extracts the one or more data transformation functions from the first data configuration file. For example, transformation function conversion system 110 may use parsing service 112 to extract the data transformation functions. Parsing service 112 may parse and/or perform syntax analysis for the one or more data transformation functions 120. Each of the one or more data transformation functions 120 may have a corresponding abstract syntax tree. The abstract syntax tree may represent the structure of the function and/or include the operations of the function. The abstract syntax trees may be used at 330 to determine corresponding data transformation functions 130 for the second data consolidation tool. In some embodiments, transformation function conversion system 110 receives the first data transformation functions 120 directly. In this instance, data transformation functions 120 may not need to be extracted. Additionally, in some embodiments data transformation functions 120 may be included in a data container rather than configuration file.

At 330, transformation function conversion system 110 determines one or more second data transformation functions 130 using a mapping configuration file that indicates the one or more second data transformation functions 130 respectively corresponding to the one or more first data transformation functions 120. Configuration file building service 114 may identify the one or more second data transformation functions 130. To identify the one or more second data transformation functions 130, mapping service 116 may traverse the abstract syntax tree corresponding to each of the one or more first data transformation functions 120. Mapping service 116 may also use the mapping configuration file to determine corresponding data transformation functions 130 in the second data consolidation tool. In some embodiments, there may be a direct equivalent data transformation function in the second data consolidation tool. In some embodiments, there may be an indirect equivalent, such that one or more data transformation functions 130 of the second data consolidation tool may be used in conjunction to provide the equivalent data transformation function of the first data consolidation tool, or vice versa. The mapping configuration file may be generated and stored in configuration file building service 114 so that mapping service 116 may determine direct and indirect equivalent functions between two data consolidation tools.

Once mapping service 116 has determined the corresponding data transformation functions 130 for the second data consolidation tool, function linkage service 118 creates the linkages between each of the data transformation functions 130. The linkages and/or data transformation functions 130 may be saved and/or organized into a configuration file corresponding to the second data consolidation tool. Based on the mapping configuration file and the data transformation functions determined by mapping service 116, function linkage service 118 may create linkages for one data transformation function to the next to preserve the sequence of data transformation in an original data configuration file corresponding to the first data consolidation tool. This may also ensure that each data transformation function 130 receives the correct input from the previous data transformation function and/or provides the correct input to the following data transformation function. In some embodiments, when there are indirect equivalents, the inputs and/or outputs passed from one data transformation function to the next may not be exactly the same. However, the sequence of the data transformation functions, the inputs, and/or the outputs passed for the set of data transformation functions may still result in the same output dataset. The output dataset produced by the second data consolidation tool using data transformation functions 130 may be the same as the output dataset produced by the first data consolidation tool using data transformation functions 120.

Additionally, configuration file building service 114 may preserve the metadata corresponding to data transformation functions 120, input data sources, and/or the output dataset at the target location from the first data consolidation tool to the second data consolidation tool. For example, this metadata may corresponding to a configuration file and may be preserved in a generated configuration file corresponding to the second data consolidation tool. As discussed throughout, transformation function conversion system 110 converts the data transformation process from the first data consolidation tool to the second data consolidation tool. In some embodiments, the change in formation or parameters contained in data transformation functions 130 from data transformation functions 120 may be the first data transformation functions, which may have direct or indirect equivalents in the second data transformation tool.

At 340, transformation function conversion system 110 generates a second data configuration file corresponding to the second data consolidation tool. The second data configuration file includes the one or more second data transformation functions 130. In some embodiments, transformation function conversion system 110 may generate one or more second data configuration files. Transformation function conversion system 110 may combine the metadata, input data sources, second data transformation functions, and output dataset information into one or more data configuration files for the second data consolidation tool. In some embodiments, transformation function conversion system 110 may also generate GUI information to visually represent each of the input data sources, second data transformation functions, and/or output dataset, as described in FIG. 2. In some embodiments, GUI 200 may be compatible with the existing GUI in the second data consolidation tool. In some embodiments, transformation function conversion system 110 may generate second data transformation functions 130 directly. In this instance, a second configuration file for the second data consolidation tool may not be generated. Additionally, in some embodiments, data transformation functions 130 may be included in a data container rather than configuration file. Transformation conversion system 110 may generate a data identifier (DID) that allows data transformation functions 130 to be executed on the second data consolidation tool and/or perform a data transformation process to produce an equivalent output as first data transformation functions 120 executed in the first data consolidation tool.

In some embodiments, transformation function conversion system 110 may save and/or store data configuration files and/or data transformation functions 130. The stored files may be transmitted to a database, computer system, server, cloud computing system, user device, or any system that may execute the second data consolidation tool. Data configuration files and/or data transformation functions 130 may be stored while the second data consolidation tool is in use and/or deleted after they have been transmitted. In some embodiments, within an organization, multiple sub-organizations or individual users may access and/or request a copy of the data configuration files and/or data transformation functions 130.

At 350, transformation function conversion system 110 executes the one or more second data transformation functions 130 in the second data configuration file. The one or more second data transformation functions 130 in the second data configuration file may be executed by transformation function conversion system 110 and/or a second data consolidation tool. For example, a computing system and/or enterprise computing system may implement both transformation function conversion system 110 and second data consolidation tool. In some embodiments, the output data configuration file and/or the data transformation functions 130 may be executed by the second data consolidation tool on computer system 400 described with reference to FIG. 4. In some embodiments, when executed the second data consolidation tool may display GUI 200. The visual representation of the data transformation process including data sources 210, second data transformation functions 220, and/or the output 230 may be visually represented by icons. In some embodiments, the data transformation process can be modified directly through interaction with GUI 200. For example, data sources 210 and/or second data transformation functions 220 may be added, removed, or replaced. In some embodiments, different data sources and/or data transformation functions may be chosen from a menu and/or dragged and dropped into place in the visual representation of the data transformation process. The execution of the data transformation functions may generate output data or an output dataset according to the data transformation functions selected.

FIG. 3B depicts a flowchart illustrating a method 300B for identifying a replacement data transformation function in response to identifying a lack of a direct or indirect equivalent data transformation function, according to some embodiments. Method 300B may be applied at 330 of method 300A. Method 300B shall be described with reference to FIGS. 1A, 1B, 2, and 3A; however, method 300B is not limited to that example embodiment.

In an embodiment, transformation function conversion system 110 may utilize method 300B to select a replacement data transformation function for one or more of the second data transformation functions. As discussed above, there may be instances where there are indirect but equivalent second data transformation functions. For example, this may occur when two second data transformation functions are used to replace one first data transformation function. However, there may be instances where the mapping configuration file is incomplete or not updated to the current functionality of a data transformation tool. In this case, there may not be a direct or indirect equivalent data transformation function. In response to identifying this scenario, mapping service 116 may suggest a replacement that may be a next-best or default data transformation function. The foregoing description will describe an embodiment of the method 300B with respect to transformation function conversion system 110. Method 300B is described with reference to transformation function conversion system 110 and may be executed on any computing device, such as, for example, the computer system described with reference to FIG. 4 and/or processing logic that may comprise hardware (e.g., circuitry dedicated logic, programmable logic, microcode, etc.), software (e.g., instructions executing on a processing device), or combination thereof. Additionally, method 300B describes the conversion of a single data configuration file and/or data transformation function 120, but the method may be automatically performed iteratively for each data configuration file and/or data transformation function 120 received by transformation function conversion system 110. This allows transformation function conversion system 110 to efficiently convert data configuration files from one data consolidation tool to another, speeding up the migration process for an organization and/or user, even when there is an error in mapping because transformation function conversion system 110 may be able to efficiently detect and alert the user to the location of the potential error.

At 330B, transformation function conversion system 110 determines that at least one of the first data transformation functions 120 does not have corresponding second data transformation function indicated in the mapping configuration file. This determination may occur after 320 from FIG. 3A and/or may be performed by configuration file building service 114. In some embodiments, the mapping configuration file may not indicate a direct or indirect equivalent for at least one of the first data transformation functions. Mapping service 116 may determine this by traversing the abstract syntax tree for the first data transformation function and utilizing the mapping configuration file, as described with reference to method 300A. For example, one of the first data transformation functions may be an “insert” data transformation function. However, there may be no corresponding mapping in mapping configuration file 116 to indicate the corresponding “insert” second data transformation function. This may occur for several reasons. For example, the second data consolidation tool may have been updated, but the corresponding mapping configuration file may not have been updated. Similarly, there may have been an error in the abstract syntax tree.

At 330C, transformation function conversion system 110 selects a replacement data transformation function 130 for the second data configuration file for the second data consolidation tool. This may be performed by configuration file building service 114. In some embodiments, this may be a default data transformation function. For example, there may be a null function that can be used. The null function may not perform any data transformation. Rather, the null function may act as a placeholder function. In some embodiments, the mapping configuration file may indicate similar functions and/or try to replace the first data transformation function with a non-equivalent function. In some embodiments, configuration file building service 114 may remove that data transformation function from the data transformation process from the first data configuration file. In some scenarios, these alternative functions may create an incorrect output when second data configuration file and/or data transformation function 130 is executed at 350 of method 300A. In some embodiments, transformation conversion system 110 may directly select the replacement data transformation function(s) and execute data transformation functions 130 in the second data consolidation tool without generating a configuration file or data container.

In some embodiments, when configuration file building service 114 selects a non-equivalent data transformation instruction, transformation function conversion system 110 may generate an alert to be included in GUI 200. This alert may be text based and/or indicate that a non-equivalent selection was made. In some embodiments, GUI 200 may highlight the selected data transformation function. This alert may allow the user of the second data consolidation tool to quickly identify the erroneous data transformation function, resolve the error, and/or select a replacement second data transformation function. As previously explained, this selection may be from a library of data transformation functions.

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method, comprising:
receiving one or more first data transformation functions defined for a first data consolidation tool;
determining one or more second data transformation functions using a mapping configuration file that indicates the one or more second data transformation functions respectively corresponding to the one or more first data transformation functions, wherein the one or more second data transformation functions correspond to a second data consolidation tool; and
executing the one or more second data transformation functions using the second data consolidation tool.

2. The computer implemented method of claim 1, wherein the determining further comprises:
traversing one or more abstract syntax trees respectively corresponding to the one or more data transformation functions, wherein the mapping configuration file indicates a first function in the first data consolidation tool corresponding to a second function in the second data consolidation tool based on the corresponding abstract syntax tree of the first function.

3. The computer implemented method of claim 1, wherein the determining further comprises:
preserving metadata corresponding to the one or more first data transformation functions in a configuration file that includes the one or more second data transformation functions.

4. The computer implemented method of claim 1, wherein the determining further comprises:
preserving a sequence of functions of the one or more first data transformation functions defined for the first data consolidation tool in a configuration file that includes the one or more second data transformation functions.

5. The computer implemented method of claim 1, further comprising:
generating visual information that is translated from a first format associated with the first data consolidation tool to visual information compatible with being displayed on the second data consolidation tool when the one or more second data transformation functions are executed in the second data consolidation tool.

6. The computer implemented method of claim 1, further comprising:
determining at least one first data transformation function does not have a corresponding second data transformation function indicated in the mapping configuration file; and
selecting a replacement data transformation function for the second data consolidation tool.

7. The computer implemented method of claim 1, wherein the respectively corresponding data transformation function defined for the second data consolidation tool is comprised of two or more individual functions that perform the data transformation of an individual data transformation function defined in the first data consolidation tool.

8. A system, comprising:
a memory; and
at least one processor coupled to the memory and configured to:
receive one or more first data transformation functions defined for a first data consolidation tool;
determine one or more second data transformation functions using a mapping configuration file that indicates the one or more second data transformation functions respectively corresponding to the one or more first data transformation functions, wherein the one or more second data transformation functions correspond to a second data consolidation tool; and
execute the one or more second data transformation functions using the second data consolidation tool.

9. The system of claim 8, wherein to determine the one or more second data transformation functions, the at least one processor is further configured to:
traverse one or more abstract syntax trees respectively corresponding to the one or more data transformation functions, wherein the mapping configuration file indicates a first function in the first data consolidation tool corresponding to a second function in the second data consolidation tool based on the corresponding abstract syntax tree of the first function.

10. The system of claim 8, wherein to determine the one or more second data transformation functions for the second data consolidation tool, the at least one processor is further configured to:
preserve metadata corresponding to the one or more first data transformation functions in a configuration file that includes the one or more second data transformation functions.

11. The system of claim 8, wherein to determine the one or more second data transformation functions for the second data consolidation tool, the at least one processor is further configured to:
preserve a sequence of functions of the one or more first data transformation functions defined for the first data consolidation tool in a configuration file that includes the one or more second data transformation functions.

12. The system of claim 8, wherein the at least one processor is further configured to:
generate visual information that is translated from a first format associated with the first data consolidation tool to visual information compatible with being displayed on the second data consolidation tool when the one or more second data transformation functions are executed in the second data consolidation tool.

13. The system of claim 8, wherein the at least one processor is further configured to:
determine at least one first data transformation function does not have a corresponding second data transformation function indicated in the mapping configuration file; and
select a replacement data transformation function for the second data consolidation tool.

14. The system of claim 8, wherein the respectively corresponding data transformation function defined for the second data consolidation tool is comprised of two or more individual functions that perform the data transformation of an individual data transformation function defined in the first data consolidation tool.

15. A non-transitory computer-readable device having instructions stored thereon that, when executed by at least one computing device, cause the at least one computing device to perform operations comprising:
receiving one or more first data transformation functions defined for a first data consolidation tool;
determining one or more second data transformation functions using a mapping configuration file that indicates the one or more second data transformation functions respectively corresponding to the one or more first data transformation functions, wherein the one or more second data transformation functions correspond to a second data consolidation tool; and
executing the one or more second data transformation functions using the second data consolidation tool.

16. The non-transitory computer-readable device of claim 15, wherein determining further comprises:
traversing one or more abstract syntax trees respectively corresponding to the one or more data transformation functions, wherein the mapping configuration file indicates a first function in the first data consolidation tool corresponding to a second function in the second data consolidation tool based on the corresponding abstract syntax tree of the first function.

17. The non-transitory computer-readable device of claim 15, wherein determining further comprises:
preserving metadata corresponding to the one or more first data transformation functions in a configuration file that includes the one or more second data transformation functions.

18. The non-transitory computer-readable device of claim 15, the operations further comprising:
generating visual information that is translated from a first format associated with the first data consolidation tool to visual information compatible with being displayed on the second data consolidation tool when the one or more second data transformation functions are executed in the second data consolidation tool.

19. The non-transitory computer-readable device of claim 15, the operations further comprising:
determining at least one first data transformation function does not have a corresponding second data transformation function indicated in the mapping configuration file; and
selecting a replacement data transformation function for the second data consolidation tool.

20. The non-transitory computer-readable device of claim 15, wherein the respectively corresponding data transformation function defined for the second data consolidation tool is comprised of two or more individual functions that perform the data transformation of an individual data transformation function defined in the first data consolidation tool.
